(19) United States
(12) Patent Application Publication
(10) Pub. No.: US 2026/0194085 A1
(43) Pub. Date: Jul. 9, 2026

(54) STEPLESS UNLOCKING FIXING DEVICE

(71) Applicant: HANWIT PRECISION INDUSTRIES LTD., New Taipei City (TW)

(72) Inventors: Ying-Chih TSENG, New Taipei City (TW); Ming-De WU, New Taipei City (TW)

(21) Appl. No.: 19/009,194

(22) Filed: Jan. 3, 2025

(51) Int. Cl. F16B 1/04

(52) U.S. Cl. CPC F16B 1/04

(57) ABSTRACT

A stepless unlocking fixing device includes a base provided with a bottom plate, two side plates, a receiving cavity, a through hole on the bottom and a buckle at one end, a lever having a cam portion pivotally connected to the base in the receiving cavity, an operating portion extended from the cam portion toward the buckle, a contact portion and an arc surface formed on the cam portion, a first abutting portion and a second abutting portion respectively formed on top and bottom sides of the arc surface, and a support having a positioning plate, an abutting rod protruded from the positioning plate and inserted through the through hole into the receiving cavity, a contact surface formed on the top of the abutting rod, a interference portion with a wider width formed on the side of the abutting rod and a locking portion with a smaller width formed below.

### BACKGROUND OF THE INVENTION

### 1. Field of the Invention

The present invention relates to a stepless unlocking fixing device, particularly a fixing device that forms a fully unlocking state when the contact portion and the arc surface of the lever are not in contact with the abutting rod of the support; a buffer unlocked state is formed when the contact portion of the lever is in contact with the contact surface and the first abutting portion is in contact with the interference portion of the support; a fully locked state is formed when the contact portion of the lever is in contact with the contact surface, the second abutting portion is in contact with the locking portion of the support, and the operating portion of the lever and the buckle of the base are engaged and positioned. By the above, the purpose of one-time locking of the fixing device and the stepless buffer unlocking is achieved to prevent the fixing device from being damaged due to instantaneous rotation resistance stress.

### 2. Description of the Related Art

With the rapid development of industrial technology, various industrial products such as computers, televisions, telephones, refrigerators, washing machines, wardrobes, drawers or desks have long become indispensable items in people's lives. The aforementioned industrial products are mostly composed of multiple components, such as the computer housing, the circuit board and the heat sink inside the TV housing, the desk panel and supporting side panels, etc., and most of the components are assembled together by locking with screws. The industrial products can be disassembled into multiple components for easy transportation, and then the assembled industrial products can be partially disassembled for maintenance or replacement.

Furthermore, since the components of the aforementioned industrial products are assembled and combined with each other by means of screw locking, when assembling the components of the industrial products, the components whose surfaces are pressed by the heads of the screws are often damaged by being screwed too tightly, such as being dented or broken. In order to solve the aforementioned problem of component damage caused by screw locking, some manufacturers also use welding to assemble the components. However, this design will make it difficult to disassemble some components of the assembled industrial product, thereby causing difficulties in repairing or replacing components.

Therefore, how to solve the various problems caused by the assembly methods of the components of the aforementioned industrial products is the direction that the relevant manufacturers engaged in this industry are eager to study and improve.

### SUMMARY OF THE INVENTION

Therefore, in view of the above problems and deficiencies, the inventor collected relevant information and, after multiple evaluations and considerations, designed the invention of this stepless unlocking fixing device.

The main object of the present invention is to provide a stepless unlocking fixing device, which comprises a base, a lever and a support. The base comprises a bottom plate, two side plates, a receiving cavity surrounded by the bottom plate and the two side plates, a through hole provided in the middle of the bottom plate, and a buckle provided on one end of the bottom plate. The lever comprises a cam portion pivotally connected between the two side plates of the base and received in the receiving cavity, an operating portion extended from the cam portion toward the buckle, a contact portion and an arc surface formed on one side of the cam portion opposite to the operating portion, a first abutting portion formed on one side of the arc surface near the contact portion, and a second abutting portion formed on an opposite side of the arc surface away from the contact portion. The support comprises a positioning plate, an abutting rod protruding upward from the positioning plate and being capable of extending into the through hole of the base and entering into the receiving cavity, a contact surface formed on a top side of the abutting rod, an interference portion with a larger width formed on the periphery of the abutting rod at an upper side, and a locking portion with a smaller width formed on the periphery of the abutting rod at a bottom of the interference portion. Through the above, when the contact portion and the arc surface are not in contact with the abutting rod, a fully unlocked state is formed; when the contact portion is in contact with the contact surface and the first abutting portion is in contact with the interference portion, a buffer unlocked state is formed; when the contact portion is in contact with the contact surface, the second abutting portion is in contact with the locking portion, and the operating portion and the buckle are engaged and positioned, a fully locked state is formed. By the above, the purpose of one-time locking of the fixing device and the stepless buffer unlocking is achieved to prevent the fixing device from being damaged due to instantaneous rotation resistance stress.

Another object of the present invention is that the base further comprises two first positioning holes respectively located on the two side plates relative to a first side of the abutting rod, and the lever further comprises an axial hole provided in the cam portion corresponding to said first positioning holes and positioned with the first positioning holes through a pivot to form a pivot structure of the base and the lever.

Still another object of the present invention is that the lever further comprises an elastic member mounted on the pivot. The elastic member comprises two ring portions mounted around the pivot and located between the two side plates of the base and the cam portion of the lever, a locating portion extended from the two ring portions toward the operating portion of the lever and abutted against a positioning surface on the bottom side of the operating portion, and two abutting end portions respectively extended from an opposite side of the two ring portions relative to the locating portion and contacted with the bottom plate of said base, and the elastic member is formed of a torsion spring.

Still another object of the present invention is that the base further comprises two second positioning holes respectively located on the two side plates relative to a second side of the abutting rod, a stopper rod supported laterally by the abutting rod and inserted and positioned in the second positioning holes, and at least one engaging portion protruded downward from a bottom surface of the bottom plate for being engaged in a first fixing hole of a preset first plate.

Still another object of the present invention is that the cam portion of the lever is provided with a top surface formed on a top side thereof which is in an arc shape to avoid the stopper rod, and the top surface extends forward to form the convex contact portion of the lever; the operating portion of the lever is provided with a slot for the buckle with a hooked end to be inserted into and positioned.

Still another object of the present invention is that the positioning plate of the support is cut on one side to form an anti-rotation directional cutting edge, and the positioning plate having the anti-rotation directional cutting edge is fixed in a second fixing hole of a preset second plate; the abutting rod of the support is formed with a tapered surface that is tapered inward between the interference portion and the locking portion, and the locking portion is formed with an inclined surface which is tapered outwardly downward and allows the arc surface of the cam portion to avoid.

### BRIEF DESCRIPTION OF THE DRAWINGS

FIG. 1 is a three-dimensional external view of the fixing device of the present invention.

FIG. 2 is a three-dimensional exploded view of the fixing device of the present invention.

FIG. 3 is a three-dimensional exploded view of the fixing device of the present invention from another viewing angle.

FIG. 4 is a side cross-sectional view of the fixing device of the present invention in the fully unlocked state.

FIG. 5 is a side cross-sectional view of the fixing device of the present invention in the buffer unlocked state.

FIG. 6 is a side cross-sectional view of the fixing device of the present invention in the fully locked state.

FIG. 7 is a three-dimensional external view of another embodiment of the fixing device of the present invention.

FIG. 8 is a three-dimensional exploded view of another embodiment of the fixing device of the present invention.

FIG. 9 is a three-dimensional exploded view of another embodiment of the fixing device of the present invention from another viewing angle.

FIG. 10 is a side cross-sectional view of another embodiment of the fixing device of the present invention in the buffer unlocked state.

FIG. 11 is a three-dimensional external view of an application example of the fixing device of the present invention in the fully unlocked state.

FIG. 12 is a three-dimensional external view of the application example of the fixing device of the present invention in the fully locked state.

### DETAILED DESCRIPTION OF THE PREFERRED EMBODIMENT

In order to achieve the above-mentioned objects and effect, the technical means and structure adopted by the present invention are described in detail with reference to the preferred embodiments of the present invention, and its features and functions are as follows for a complete understanding.

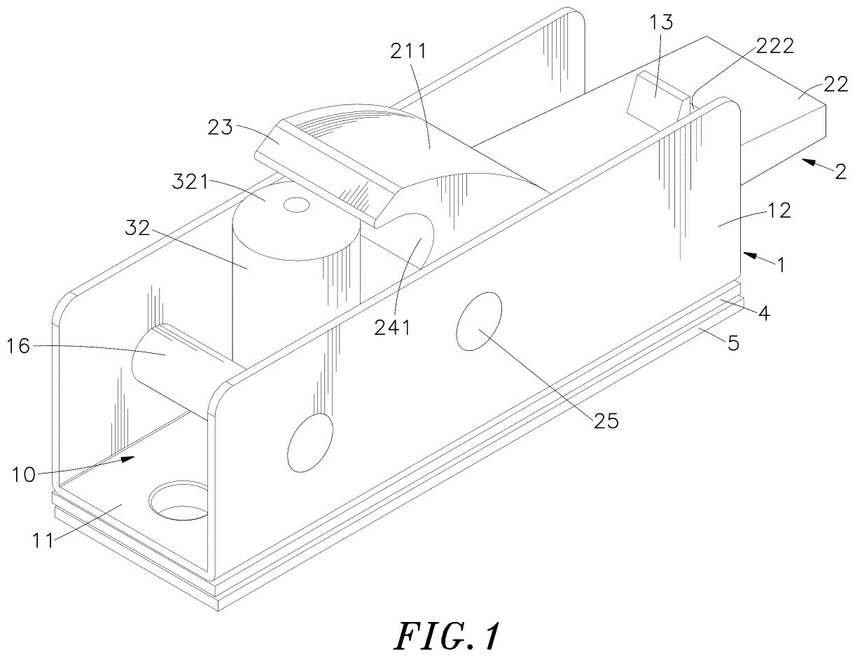

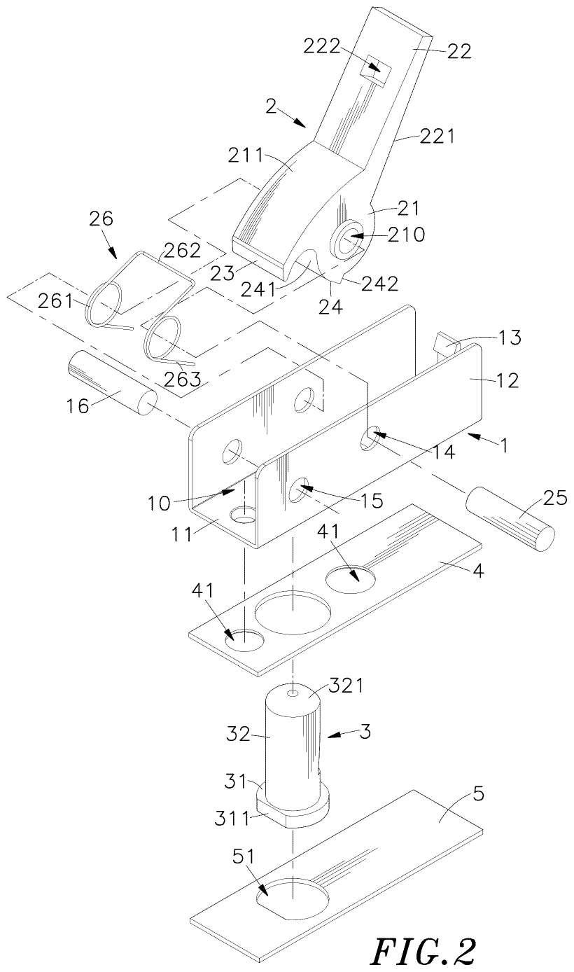

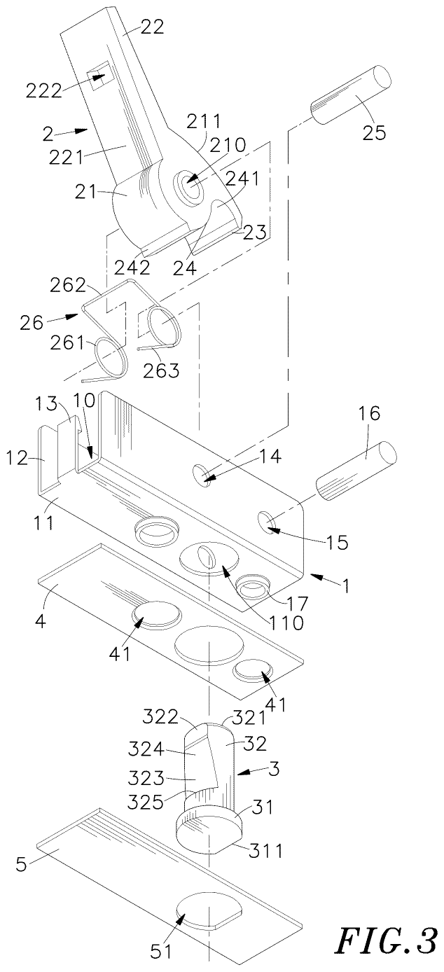

Please refer to FIGS. 1 to 6, which are respectively a three-dimensional external view, a three-dimensional exploded view, a three-dimensional exploded view from another viewing angle, a side cross-sectional view in the fully unlocked state, a side cross-sectional view in the buffer unlocked state, and a side cross-sectional view in the fully locked state of the fixing device of the present invention. As can be clearly seen from the figures, the fixing device of the present invention mainly comprises a base 1, a lever 2 and a support 3, and its main components and features are described in detail as follows:

The base 1 comprises a bottom plate 11, two side plates 12, a receiving cavity 10 surrounded by the bottom plate 11 and the two side plates 12, a through hole 110 provided in the middle of the bottom plate 11, and a buckle 13 provided on one end of the bottom plate 11.

The lever 2 comprises a cam portion 21 pivotally connected between the two side plates 12 of the base 1 and received in the receiving cavity 10, an operating portion 22 extended from the cam portion 21 toward the buckle 13, a contact portion 23 and an arc surface 24 formed on one side of the cam portion 21 opposite to the operating portion 22, a first abutting portion 241 formed on one side of the arc surface 24 near the contact portion 23, and a second abutting portion 242 formed on an opposite side of the arc surface 24 away from the contact portion 23.

The support 3 comprises a positioning plate 31, an abutting rod 32 protruding upward from the positioning plate 31 and being capable of extending into the through hole 110 of the base 1 and entering into the receiving cavity 10, a contact surface 321 formed on a top side of the abutting rod 32, an interference portion 322 with a larger width formed on the periphery of the abutting rod 32 at an upper side, and a locking portion 323 with a smaller width formed on the periphery of the abutting rod 32 at a bottom of the interference portion 322. When the contact portion 23 and the arc surface 24 are not in contact with the abutting rod 32, a fully unlocked state is formed. When the contact portion 23 is in contact with the contact surface 321 and the first abutting portion 241 is in contact with the interference portion 322, a buffer unlocked state is formed. When the contact portion 23 is in contact with the contact surface 321, the second abutting portion 242 is in contact with the locking portion 323, and the operating portion 22 and the buckle 13 are engaged and positioned, a fully locked state is formed.

The above-mentioned base 1 further comprises two first positioning holes 14 respectively located on the two side plates 12 relative to a first side of the abutting rod 32, and an axial hole 210 is provided in the cam portion 21 of the lever 2 corresponding to the first positioning holes 14. The two first positioning holes 14 and the axial hole 210 are positioned through a pivot 25 to form a pivot structure of the base 1 and the lever 2. The pivot 25 is mounted with an elastic member 26 outside. The elastic member 26 comprises two ring portions 261 mounted around the pivot 25 and located between the two side plates 12 of the base 1 and the cam portion 21 of the lever 2, a locating portion 262 extended from the two ring portions 261 toward the operating portion 22 of the lever 2 and abutted against a positioning surface 221 on the bottom side of the operating portion 22, and two abutting end portions 263 respectively extended from an opposite side of the two ring portions 261 relative to the locating portion 262 and contacted with the bottom plate 11 of the base 1. The elastic member 26 is formed of a torsion spring.

The above-mentioned base 1 further comprises two second positioning holes 15 respectively located on the two side plates 12 relative to a second side of the abutting rod 32, the two second positioning holes 15 is for a stopper rod 16 supported laterally by the abutting rod 32 to be inserted and positioned, and at least one engaging portion 17 protruded downward from the bottom surface of the bottom plate 11 of the base 1 for being engaged in a first fixing hole 41 of a preset first plate 4.

The cam portion 21 of the lever 2 has a top surface 211 formed on the top side thereof which is in an arc shape and can avoid the stopper rod 16. The top surface 211 extends forward to form the convex contact portion 23. The operating portion 22 of the lever 2 is provided with a slot 222 for the buckle 13 with a hooked end to be inserted into and positioned.

The positioning plate 31 of the support 3 is cut on one side to form an anti-rotation directional cutting edge 311, and the positioning plate 31 having the anti-rotation directional cutting edge 311 is fixed in the second fixing hole 51 of the preset second plate 5. The abutting rod 32 of the support 3 is formed with a tapered surface 324 that is tapered inward between the interference portion 322 and the locking portion 323, and the locking portion 323 is formed with an inclined surface 325 which is tapered outwardly downward and allows the arc surface 24 of the cam portion 21 to avoid.

When the fixing device of the present invention is to be assembled, firstly, the two ring portions 261 of the elastic member 26 are aligned with the two sides of the axial hole 210 of the lever 2, and the locating portion 262 is abutted against the positioning surface 221 on the bottom side of the operating portion 22. Then, the lever 2 is placed into the base 1 to align the axial hole 210 with the two first positioning holes 14, and the pivot 25 is inserted and positioned, and the two abutting end portions 263 of the elastic member 26 are tilted to contact the bottom plate 11 of the base 1. Finally, the stopper rod 16 is inserted into the two second positioning holes 15 of the base 1 to form a positioning, thereby completing the assembly of the base 1 and the lever 2. The assembled structure of the base 1 and the lever 2 is fixed by engaging and fixing at least one engaging portion 17 on the bottom side of the base 1 into the first fixing hole 41 of the first plate 4 so that the assembly structure of the base 1, the lever 2 and the first plate 4 is completed. The positioning plate 31 of the support 3 is fixed in the second fixing hole 51 of the second plate 5 to complete the assembly structure of the support 3 and the second plate 5.

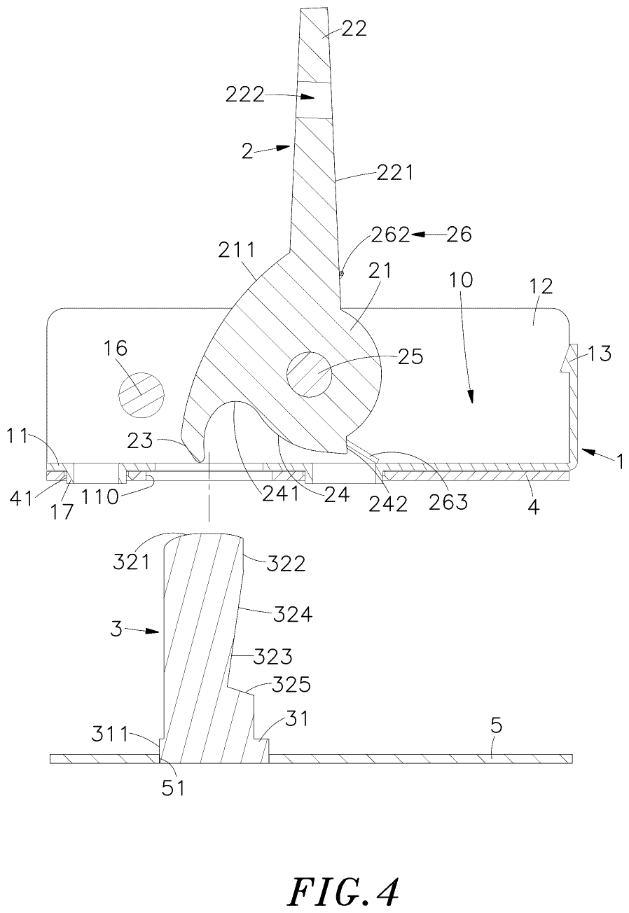

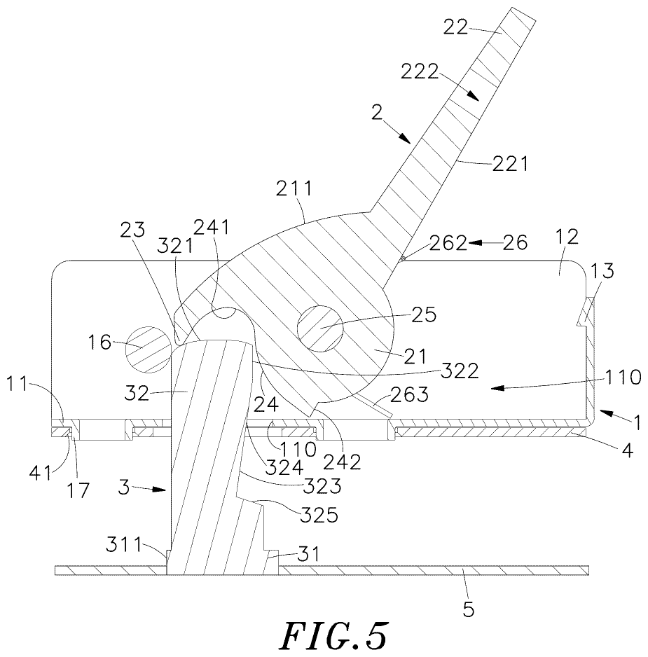

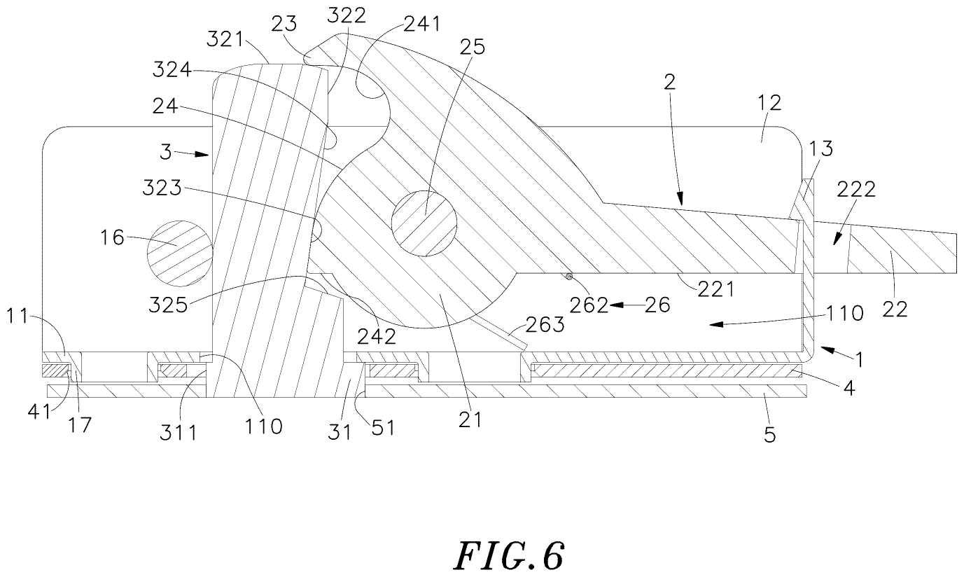

Please refer to FIG. 4, which shows that the base 1 and the lever 2 are fixed on the first plate 4 and the support 3 is fixed on the second plate 5. This is the fully unlocked state of the fixing device. As shown in FIG. 5, when the first plate 4 is moved downward to approach the second plate 5 by applying force, the abutting rod 32 of the support 3 extends into the through hole 110 of the base 1 and enters the receiving cavity 10. The contact surface 321 of the abutting rod 32 and the contact portion 23 of the lever 2 are first in contact and abutted against each other, and the lever 2 is pushed to rotate in a clockwise direction. Then, the interference portion 322 of the support 3 and the first abutting portion 241 of the lever 2 are also in contact and abutted against each other and generate a smaller interference resistance (because the first abutting portion 241 is closer to the axial hole 210). This is the buffer unlocked state of the fixing device, which can buffer the rotational stress generated by the lever 2 during the locking process and effectively avoid overall damage to the fixing device. Please refer to FIG. 6, when the surface of the positioning plate 31 of the support 3 abuts against the bottom plate 11 of the base 1 to form a blocking position, at the same time, the abutting rod 32 also pushes the lever 2 to rotate, and keeps the contact portion 23 of the lever 2 and the contact surface 321 of the abutting rod 32 in contact and abutment. The second abutting portion 242 and the locking portion 323 of the support 3 are in contact and abutted against each other and generate a larger interference resistance (because the second abutting portion 242 is farther from the axial hole 210). Then, force is applied to the operating portion 22 of the lever 2 so that the slot 222 and the buckle 13 of the base 1 are engaged and positioned and the elastic member 26 is compressed. This is the fully locked state of the fixing device, so that the first plate 4 and the second plate 5 can form a combined fixing structure.

To separate and disassemble the first plate 4 and the second plate 5, first apply force to push the hook-shaped buckle 13 located in the slot 222 of the lever 2 outward to form a non-interference state. The elastic member 26 exerts a restoring force on the lever 2, causing the lever 2 to rotate counterclockwise and disengage from the buckle 13. Then, force is applied to the operating portion 22 of the lever 2 to pull up and make the contact portion 23 of the lever 2 continues to press on the contact surface 321 of the support 3, so that the first plate 4 moves upward and away from the second plate 5, and the abutting rod 32 of the support 3 is separated from the through hole 110 of the base 1. Through the above operations, the separation and disassembly of the first plate 4 and the second plate 5 is completed.

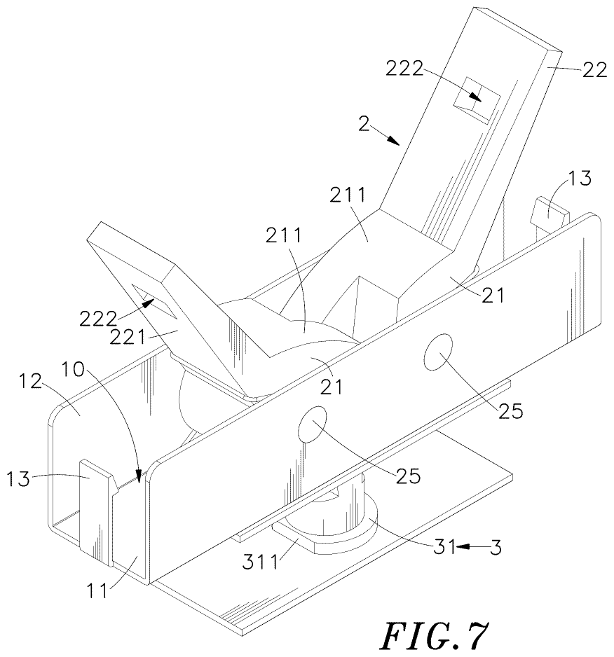

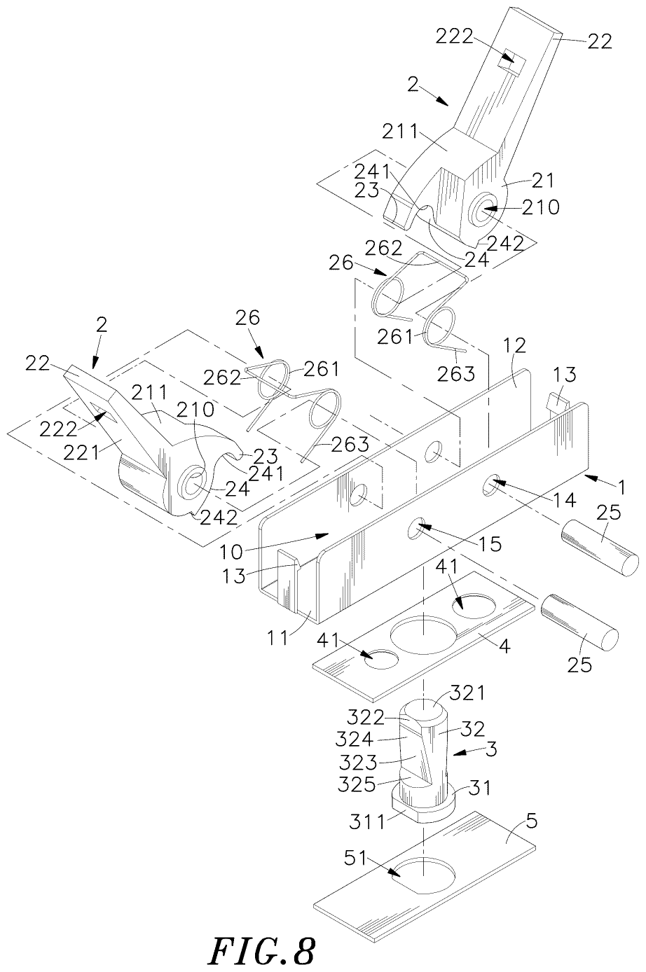

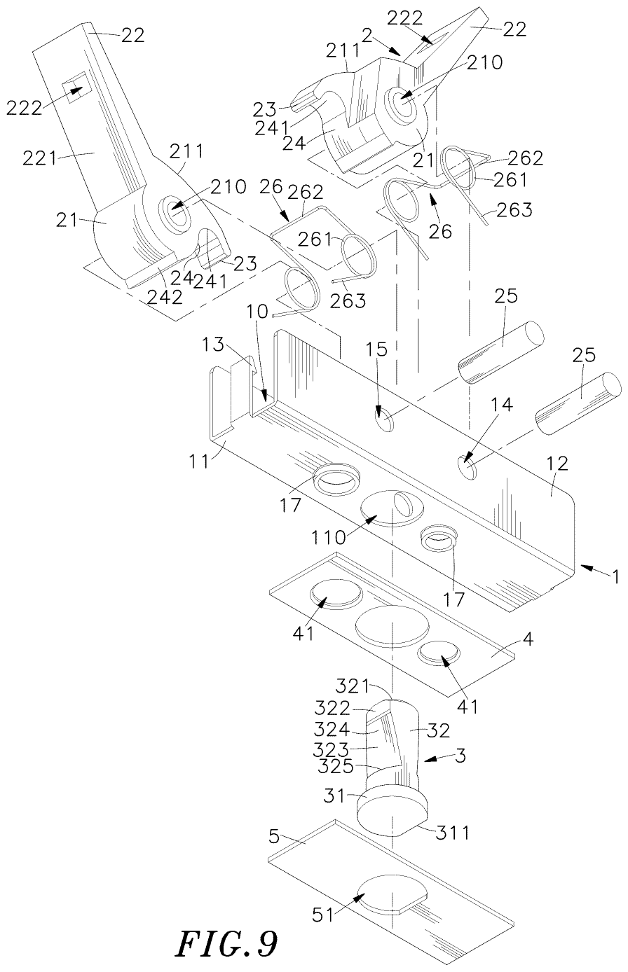

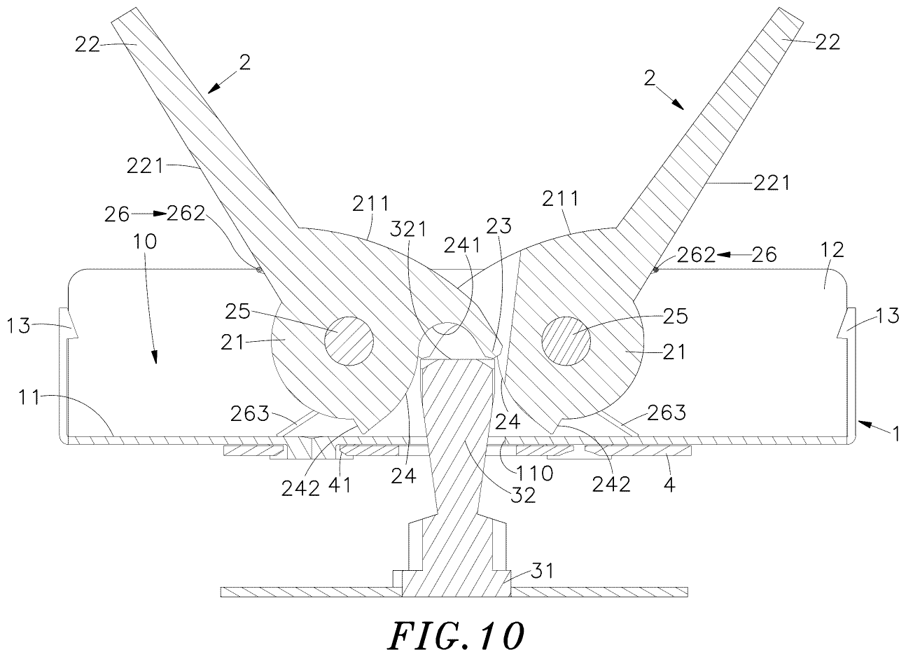

Please refer to FIGS. 7 to 10, which are respectively a three-dimensional external view, a three-dimensional exploded view, a three-dimensional exploded view from another viewing angle, and a side cross-sectional view in the buffer unlocked state of another embodiment of the fixing device of the present invention. The difference between this embodiment and that disclosed in FIGS. 1 to 6 is that this embodiment uses two levers 2 of the same structure and symmetrically pivotally connected between the two side plates 12 of the base 1. Both levers 2 can be unlocked by rotating them toward the center and can be locked by rotating them toward the two sides. The abutting rod 32 of the support 3 is formed with an upper interference portion 322 and a lower locking portion 323 on each of both sides. The advantage of this embodiment is that it achieves better locking effect by forming a larger locking force through two levers 2. Its main components and features are described as follows: The fixing device of this embodiment comprises a base 1, two levers 2, and a support 3.

The base 1 comprises a bottom plate 11, two side plates 12, a receiving cavity 10 surrounded by the bottom plate 11 and the two side plates 12, a through hole 110 provided in the middle of the bottom plate 11, and two buckles 13 respectively provided on two opposite ends of the bottom plate 11.

The two levers 2 are of the same structure and symmetrically pivotally connected between the two side plates 12 of the base 1, both of which can be rotated toward the center to unlock and rotated toward the two sides to lock. The single lever 2 comprises a cam portion 21 received in the receiving cavity 10, an operating portion 22 extended from the cam portion 21 toward one respective buckle 13, a contact portion 23 and an arc surface 24 formed on one side of the cam portion 21 opposite to the operating portion 22, a first abutting portion 241 formed on one side of the arc surface 24 near the contact portion 23, and a second abutting portion 242 formed on an opposite side of the arc surface 24 away from the contact portion 23.

The support 3 comprises a positioning plate 31, an abutting rod 32 protruding upward from the positioning plate 31 and being capable of extending into the through hole 110 of the base 1 and entering into the receiving cavity 10, a contact surface 321 formed on a top side of the abutting rod 32, an interference portion 322 with a larger width formed on the periphery of the abutting rod 32 at an upper side, and a locking portion 323 with a smaller width formed on the periphery of the abutting rod 32 at a bottom of the interference portion 322. When the contact portion 23 and the arc surface 24 are not in contact with the abutting rod 32, a fully unlocked state is formed. When the contact portion 23 is in contact with the contact surface 321 and the first abutting portion 241 is in contact with the interference portion 322, a buffer unlocked state is formed. When the contact portion 23 is in contact with the contact surface 321, the second abutting portion 242 is in contact with the locking portion 323, and the operating portion 22 and the respective buckle 13 are engaged and positioned, a fully locked state is formed.

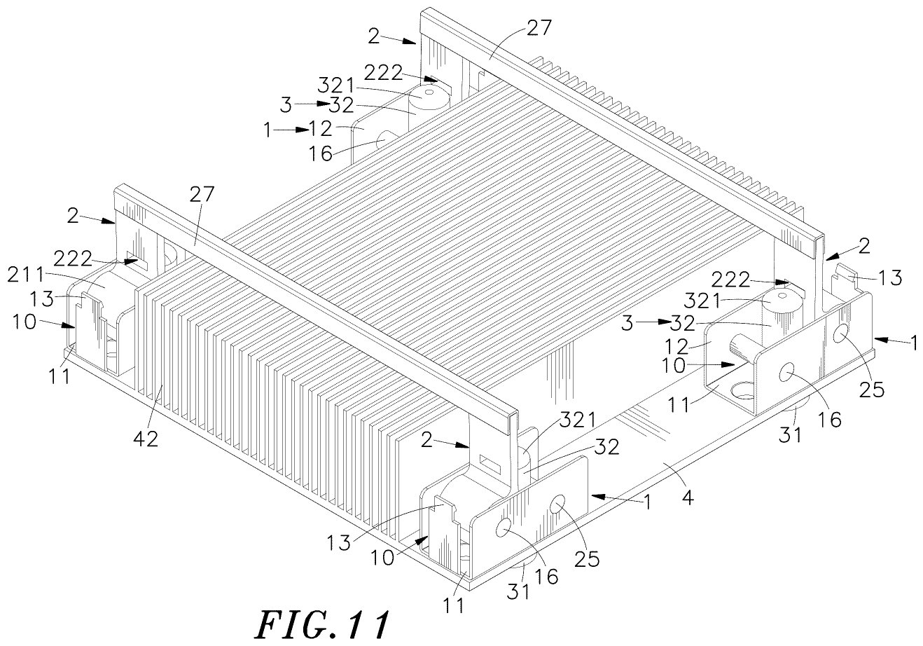

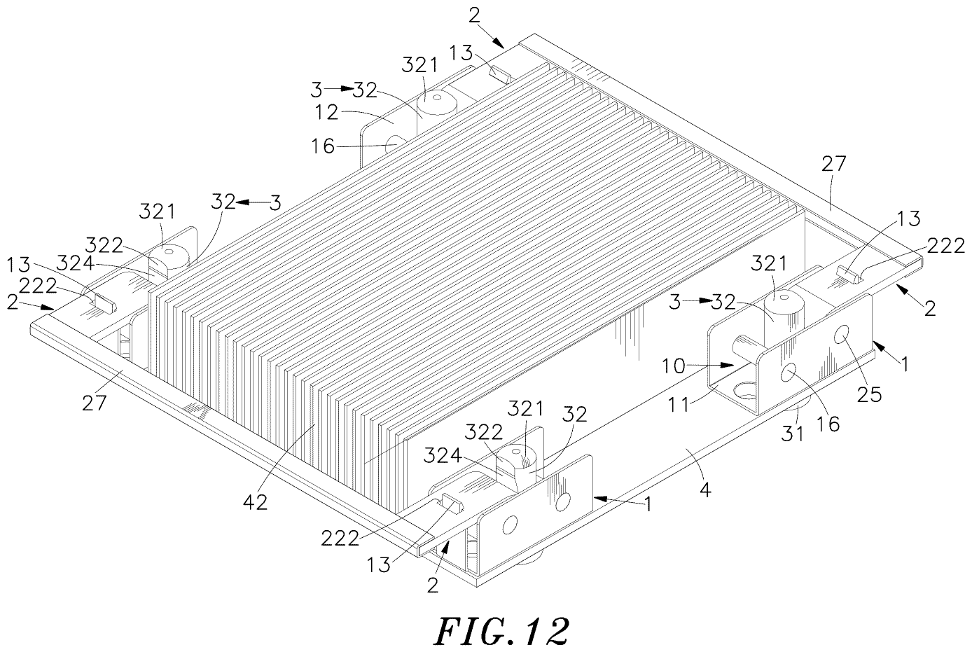

Please refer to FIGS. 11 and 12, which are three-dimensional external views of application examples of the fixing device of the present invention in the fully unlocked state and the fully locked state, respectively. The first plate 4 assembled on the bottom side of the base 1 and the levers 2 of the fixing device refers to the metal plate at the edge of a heat sink fin 42 installed on the surface of the electronic components that are prone to generate high temperature (such as: central processing unit [CPU], graphics processing unit [GPU], micro control unit [MCU] or power supply component). The second plate 5 assembled on the bottom side of the support 3 refers to the metal plate fixed to the edge of a socket (not shown) of a high-temperature electronic component on a printed circuit board (PCB). When the first plate 4 at the edge of the heat sink fin 42 is provided with four sets of base 1 and lever 2 combination structures and the second plate 5 at the edge of the socket is provided with four supports 3, and the four levers 2 are set in pairs and each pair is provided with a connecting rod 27 to make them linked. When the four levers 2 connected by the two connecting rods 27 are all at an approximately vertical angle with the base 1, the fully unlocked state is achieved. When the two connecting rods 27 rotate outward and make the four levers 2 at an approximately horizontal angle and locked at the respective buckle 13, a fully locked state is achieved. When the two connecting rods 27 rotate outward and make the four levers 2 at an angle between 1~89 degrees, the buffer unlocked state is achieved. Through the above-mentioned embodiment, the heat sink fin 42 and the socket on the circuit board can be quickly assembled and disassembled and the stepless buffer unlocking operation can be realized.

The main feature of the present invention is that when the contact portion 23 and the arc surface 24 of the lever 2 of the fixing device are not in contact with the abutting rod 32 of the support 3, a fully unlocked state is formed; when the contact portion 23 of the lever 2 is in contact with the contact surface 321 and the first abutting portion 241 is in contact with the interference portion 322 of the support 3, a buffer unlocked state is formed; when the contact portion 23 of the lever 2 is in contact with the contact surface 321, the second abutting portion 242 is in contact with the locking portion 323 of the support 3, and the operating portion 22 of the lever 2 is engaged and positioned with the buckle 13 of the base 1, a fully locked state is formed. By the above, the purpose of one-time locking of the fixing device and the stepless buffer unlocking is achieved to prevent the fixing device from being damaged due to instantaneous rotation resistance stress.

The above are only preferred embodiments of the present invention, and do not limit the patent scope of the present invention. Therefore, all simple modifications and equivalent structural changes made by using the contents of the description and drawings of the present invention should be included in the patent scope of the present invention and should be declared.

In summary, the stepless unlocking fixing device of the present invention can achieve its effect and purpose when used. Therefore, this invention is truly an invention with excellent practicality. In order to meet the application requirements for invention patents, we have filed an application in accordance with the law. We hope that the review committee will approve this case as soon as possible to protect the inventor's hard work in research and development. If the review committee has any questions, please feel free to write to us for instructions. The inventor will do his best to cooperate and we will be very grateful.

What the invention claimed is:

1. A stepless unlocking fixing device, comprising
a base comprising a bottom plate, two side plates, a receiving cavity surrounded by said bottom plate and said two side plates, a through hole provided in a middle of said bottom plate, and a buckle provided on one end of said bottom plate;
a lever comprising a cam portion pivotally connected between said two side plates of said base and received in said receiving cavity, an operating portion extended from said cam portion toward said buckle, a contact portion and an arc surface formed on one side of said cam portion opposite to said operating portion, a first abutting portion formed on one side of said arc surface near said contact portion, and a second abutting portion formed on an opposite side of said arc surface away from said contact portion; and.
a support comprising a positioning plate, an abutting rod protruding upward from said positioning plate and being capable of extending into said through hole of said base and entering into said receiving cavity, a contact surface formed on a top side of said abutting rod, an interference portion with a relative larger width formed on the periphery of said abutting rod at an upper side, and a locking portion with a relative smaller width formed on the periphery of said abutting rod at a bottom of said interference portion; and
wherein when said contact portion and said arc surface are kept away from said abutting rod, a fully unlocked state is formed; when said contact portion is in contact with said contact surface and said first abutting portion is in contact with said interference portion, a buffer unlocked state is formed; when said contact portion is in contact with said contact surface, said second abutting portion is in contact with said locking portion, and said operating portion and said buckle are engaged and positioned, a fully locked state is formed.

2. The stepless unlocking fixing device as claimed in claim 1, wherein said base further comprises two first positioning holes respectively located on said two side plates relative to a first side of said abutting rod, and said lever further comprises an axial hole provided in said cam portion corresponding to said first positioning holes and positioned with said first positioning holes through a pivot to form a pivot structure of said base and said lever.

3. The stepless unlocking fixing device as claimed in claim 2, wherein said lever further comprises an elastic member formed of a torsion spring and mounted on said pivot, said elastic member comprises two ring portions mounted around said pivot and located between said two side plates of said base and said cam portion of said lever, a locating portion extended from said two ring portions toward said operating portion of said lever and abutted against a positioning surface on the bottom side of said operating portion, and two abutting end portions respectively extended from an opposite side of said two ring portions relative to said locating portion and contacted with said bottom plate of said base.

4. The stepless unlocking fixing device as claimed in claim 1, wherein said base further comprises two second positioning holes respectively located on said two side plates relative to a second side of said abutting rod, and a stopper rod supported laterally by said abutting rod and inserted and positioned in said second positioning holes.

5. The stepless unlocking fixing device as claimed in claim 1, wherein said base further comprises at least one engaging portion protruded downward from a bottom surface of said bottom plate of said base for being engaged in a first fixing hole of a preset first plate.

6. The stepless unlocking fixing device as claimed in claim 1, wherein said cam portion of said lever is provided with a top surface formed on a top side thereof which is in an arc shape to avoid said stopper rod, and said top surface extends forward to form convex said contact portion of said lever.

7. The stepless unlocking fixing device as claimed in claim 1, wherein said operating portion of said lever is provided with a slot for said buckle with a hooked end to be inserted into and positioned.

8. The stepless unlocking fixing device as claimed in claim 1, wherein said positioning plate of said support is cut on one side to form an anti-rotation directional cutting edge, and said positioning plate having said anti-rotation directional cutting edge is fixed in a second fixing hole of a preset second plate.

9. The stepless unlocking fixing device as claimed in claim 1, wherein said abutting rod of said support is formed with a tapered surface that is tapered inward between said interference portion and said locking portion, and said locking portion is formed with an inclined surface which is tapered outwardly downward and allows said arc surface of said cam portion to avoid.

10. A stepless unlocking fixing device, comprising
a base comprising a bottom plate, two side plates, a receiving cavity surrounded by said bottom plate and said two side plates, a through hole provided in a middle of said bottom plate, and two buckles respectively provided on two opposite ends of said bottom plate;
two levers of the same structure symmetrically pivotally connected between said two side plates of said base, said two levers being rotatable toward the center to unlock and rotatable toward two opposite sides to lock, each of said two levers comprising a cam portion received in said receiving cavity, an operating portion extended from said cam portion toward one respective said buckle, a contact portion and an arc surface formed on one side of said cam portion opposite to said operating portion, a first abutting portion formed on one side of said arc surface near said contact portion, and a second abutting portion formed on an opposite side of said arc surface away from said contact portion; and
a support comprising a positioning plate, an abutting rod protruding upward from said positioning plate and being capable of extending into said through hole of said base and entering into said receiving cavity, a contact surface formed on a top side of said abutting rod, an interference portion with a relatively larger width formed on the periphery of said abutting rod at an upper side, and a locking portion with a relatively smaller width formed on the periphery of said abutting rod at a bottom of said interference portion; and
wherein when said contact portion and said arc surface are kept away from said abutting rod, a fully unlocked state is formed; when said contact portion is in contact with said contact surface and said first abutting portion is in contact with said interference portion, a buffer unlocked state is formed; when said contact portion is in contact with said contact surface, said second abutting portion is in contact with said locking portion, and said operating portion and each said buckle are engaged and positioned, a fully locked state is formed.
